(19) United States
(12) Patent Application Publication
(10) Pub. No.: US 2020/0087910 A1
(43) Pub. Date: Mar. 19, 2020

(54) Urban sewer dredging apparatus

(71) Applicant: Guozhong Wang, Guangzhou City (CN)

(72) Inventor: Guozhong Wang, Guangzhou City (CN)

(21) Appl. No.: 16/691,576

(22) Filed: Nov. 21, 2019

(30) Foreign Application Priority Data
Sep. 6, 2019 (CN) 2019108417294

(51) Int. Cl. E03F 9/00; B08B 9/051

(52) U.S. Cl. CPC E03F 9/005; B08B 9/051

(57) ABSTRACT

The utility model discloses a city sewer dredging apparatus, comprising a mounting block, a fixing rope is fixed on an upper end surface of the mounting block, and a telescopic fixing device is arranged in the mounting block, wherein the telescopic fixing device comprises a left-right symmetric circle The arc-shaped abutting block is provided with a power supply device on the lower side of the telescopic fixing device, and the power supply device includes a power motor. The small size of the invention can be directly placed in the sewer, and is suitable for different inner diameter ranges and depth ranges. In the process of sewer use, in the process of dredging and dredging, the debris and the stuck sludge in the sewer are crushed by the crushing device, the dredging speed is fast, the water source is saved, and the solid waste after the crushing is passed through the filter. Filtered and collected, this device is highly automated.

### CROSS-REFERENCES TO RELATED APPLICATIONS

The present application claims priority from Chinese application No. 2019107337678 filed on Aug. 9, 2019 which is hereby incorporated by reference in its entirety.

### TECHNICAL FIELD

The present invention relates to the technical field of sewage treatment, in particular to an urban sewer dredging apparatus.

### BACKGROUND OF THE INVENTION

The sewer is an urban public facility that can be used to discharge sewage and rainwater. However, the domestic waste that is blown away or the sludge deposited during the circulation of the sewage is easy to block the sewer. Usually, the dredging of the sewer is only washed with high-pressure water. The method is not thorough, the high-pressure water will flush the garbage or sludge in the pipeline to the next pipeline or the turning point of the pipeline. If the solid waste is not removed, the pipeline will be blocked again, or the downstream pipeline will be blocked. Secondly, the blockage is serious. Or when the sludge adheres to the sewer, it needs a lot of high-pressure water to wash, waste water resources, and it takes a long time. In addition, when the high-pressure water is still unable to dredge the pipeline, it is necessary to manually remove the debris from the pipeline, but Since the sewer pipe contains a lot of harmful gases, it is very harmful to the worker's body and easily causes suffocation. Therefore, the safety of manual dredging is low. The present invention clarifies an apparatus that solves the above problems.

### BRIEF SUMMARY OF THE INVENTION

Technical problem: the traditional sewer dredging device can not collect and remove solid debris, which is easy to cause the pipeline to be blocked again, and the device has low automation and low efficiency.

In order to solve the above problems, this example designs a city sewer dredging device, in this case, a city sewer dredging device, comprising a mounting block, the upper end surface of the mounting block is fixed with a rope, and the mounting block is The telescopic fixing device comprises a left-right symmetric arc-shaped abutting block, and the mounting block is placed in the desired position in the sewer pipe, and passes through the abutting block and the sewer pipe. The end wall is closely fitted, so that the mounting block is fixedly mounted in the sewer, the power supply device is disposed on the lower side of the telescopic fixing device, and the power supply device includes a power motor, and the power motor can work as described The telescopic fixing device is provided with a driving device, and the driving device is provided with a driving device on a lower side thereof, and the lower side of the driving device is provided with a lifting device, and the lifting device is dynamically connected with the driving device, and the lifting device includes a drill shaft. The drilling shaft is provided with a pulverizing device, which can smash and separate the debris and sludge in the sewer from the sewer, and the rotating shaft is provided with a rotating device The upper end of the rotating device can be dynamically connected to the power supply device, and the lower side of the rotating device is provided with a filtering device, and the filtering device and the rotating device are dynamically connected by a transmission device, and the filtering device includes six An extension block is provided with a retractable filter screen between the extension blocks, and when the mud and the debris are washed by the high-pressure water from the outside, the solid waste can be collected through the filter.

Wherein the telescopic fixing device comprises a rotating slot, wherein the rotating slot is provided with a first bevel gear, the lower end of the first bevel gear is dynamically connected with the power supply device, and the first bevel gear is fixed at the center a two-way screw, the left and right sides of the rotating groove are provided with a symmetrical telescopic cavity, and the telescopic cavity is slidably provided with a telescopic shaft, and the left and right ends of the two-way screw respectively extend into the telescopic cavity and the two-way wire The bar is screwed to the telescopic shaft, and the abutting block is fixed to an end of the telescopic shaft away from the first bevel gear, so that the first bevel gear drives the bidirectional screw to rotate, so that the telescopic shaft faces Moving, controlling the abutting block to closely fit the inner wall of the sewer pipe.

Wherein, the power supply device includes a power chamber, a power block is slidably disposed in the power chamber, and a left-side symmetric pressure spring is fixed on the lower end surface of the power block, and a push block is arranged on the left side of the pressure spring. The push block is fixedly disposed on the lower end surface of the power block, the lower end of the push block is in contact with the lifting device, the power block is provided with a power rotating slot, and the power motor is fixed on the upper end of the power rotating slot a spline sleeve is disposed in the power rotating slot, the upper end of the spline sleeve is dynamically connected to the power motor, and the lower end of the spline sleeve is dynamically connected to the rotating device, and the spline sleeve is fixed a driving gear is disposed, and a driven gear is coupled to the right end of the driving gear, a gear rotating shaft is fixed at a center of the driven gear, and a second bevel gear is fixed to an upper end of the gear rotating shaft, and the second bevel gear is The first bevel gears are meshingly coupled such that the power motor operates to power the telescoping fixture and the rotating device, respectively.

Wherein, the driving device comprises a driving cavity, a driving motor is fixed on a lower end wall of the driving cavity, a driving shaft is dynamically mounted on the driving motor, and a first gear is fixed on the driving shaft, and the first gear A second gear is coupled to the left end, and the second gear is fixedly coupled to the lifting device, so that operation of the driving motor can drive the lifting device to work.

Wherein, the lifting device comprises a lifting chamber, the lower side of the lifting chamber is in communication with the outside, the upper end of the drilling shaft is located in the lifting chamber, the drilling shaft is provided with a thread groove, and the thread groove is internally threaded a threaded shaft, the upper end of the threaded shaft extends into the driving cavity and is fixedly connected to the second gear, the left end surface of the drill shaft is fixed with a limiting block, and a limiting slot is disposed in the left end wall of the lifting cavity. The left end of the limiting block extends into the limiting slot, the upper side of the limiting slot is in communication with the power cavity, and the lower end of the pushing block extends into the limiting slot and is opposite to the limiting block The rotation of the threaded shaft causes the drill shaft to move up and down.

Wherein the smashing device comprises an outer drum, the outer surface of the outer drum has a vertical tooth structure, the outer drum is sleeved on the outer circumference of the drill shaft and the inner end surface of the outer drum is The drill shafts are rotatably connected by a bearing, and the inner end surface of the outer drum is meshed with an inner drum, and the inner drum is rotatably connected with the drill shaft through a bearing, and the outer drum and the inner drum Three pulverizing knives are respectively arranged, the pulverizing knives are distributed in an annular array, and the rotating block is provided in the mounting block, the rotating cavity is located in the right end wall of the lifting cavity, and the rotating cavity is provided with a straight rotation a gear, the spur gear is meshed with the outer drum, and an upper end wall of the rotating cavity is mounted with a rotating electric machine, and the spur gear is dynamically mounted with the rotating electric machine, so that the rotating electric machine works to drive the spur gear to rotate The outer drum and the inner drum rotate, and the garbage in the sewer is broken by the smashing knife to facilitate circulation.

Wherein, the filtering device comprises a rotating shaft, the upper end of the rotating shaft extends through the threaded shaft and protrudes into the power chamber, and the rotating shaft is rotatably connected with the threaded shaft through a bearing, and the rotating shaft is screwed There are six-sided cylinders, and the six sides of the six-sided cylinder are all tooth-shaped structures, so that the rotation of the rotating shaft can cause the six-sided cylinder to rise and fall.

The filtering device includes six receiving cavities, and a through cavity is communicated between the receiving cavities, and a lower end of the six-sided column extends into the through cavity, and a rotating shaft is disposed in the receiving cavity. a filtering rotating rod is fixed on the filtering rotating shaft, and an upper end surface of the filtering rotating rod is provided with a curved rack, and the curved rack is engaged with the six sides of the six-sided cylinder, and the filtering rotating rod is provided a telescopic groove is disposed in the telescopic groove, and a telescopic spring is fixed between the upper end of the telescopic rod and the telescopic groove, and a pull cord is fixed on the upper end of the telescopic rod, and the receiving cavity side is The tensioning rotary groove is disposed in the tensioning rotary groove, and the tensioning rotating wheel is disposed in the tensioning rotary groove, and the upper end of the pulling rope is connected to the transmission device after the tensioning rotating wheel is disposed, and the receiving cavity is The side of the telescopic rod extends into the annular cavity, and the extension block is fixed to the lower end of the telescopic rod, so that the six-sided cylinder descends to rotate the filter rod to the outside. So that the filter mesh is unfolded, and the extension of the telescopic rod in the telescopic groove, Such that the inner diameter of the filter to match the size of the sewer.

Wherein, the transmission device comprises a winding chamber, the winding chamber is located at an upper side of the receiving cavity, the winding chamber is provided with a winding shaft, and the winding shaft is fixed with a winding a rotating wheel, six upper ends of the pulling rope are fixedly disposed on the winding reel, a right side of the winding chamber is provided with a belt cavity, and a right end of the winding shaft is rotatably connected with a right end wall of the belt cavity a belt rotating shaft is disposed in the belt cavity, and the belt rotating shaft and the winding shaft are electrically connected by a driving belt, and a left side of the belt chamber is provided with a reversing chamber, and the left end of the belt rotating shaft extends to a third bevel gear is fixed in the reversing chamber, a fourth bevel gear is meshed on the upper side of the third bevel gear, and a transmission shaft is fixed at the center of the fourth bevel gear. a transmission slot is disposed on the upper side, the upper end of the transmission shaft extends into the transmission slot and a transmission gear is fixed, the rotation shaft extends through the transmission slot, and is fixed on the rotating shaft in the transmission slot An engaging gear is provided, and the meshing gear is meshed with the transmission gear, And said ring gear may be rotatably driven by rotation of the take-up reel controls the retractable pull cord.

The invention has the beneficial effects that the small volume of the invention can be directly placed in the sewer, fixedly installed by the telescopic fixing device and the sewer, and is suitable for use in sewers of different inner diameter ranges and depth ranges, and is crushed during the dredging process. The device smashes the clogged debris and the stuck sludge in the sewer, disperses between them, facilitates the subsequent high-pressure water scouring, clears the dredging speed, saves the water source, and the solid waste after the crushing is filtered through the filter. The collection can ensure the smooth flow of the sewer. The device has high automation, high efficiency, and safe operation.

### BRIEF DESCRIPTION OF THE DRAWINGS

For ease of description, the present invention is described in detail by the following specific embodiments and the accompanying drawings.

FIG. 1 is a schematic view showing the overall structure of a city sewer dredging device according to the present invention;

FIG. 2 is an enlarged schematic structural view of “A” of FIG. 1;

FIG. 3 is an enlarged schematic structural view of “B” of FIG. 1;

FIG. 4 is an enlarged schematic view of the structure “C” of FIG. 3;

FIG. 5 is a schematic view showing the structure of the “D-D” direction of FIG. 4.

### DETAILED DESCRIPTION OF THE INVENTION

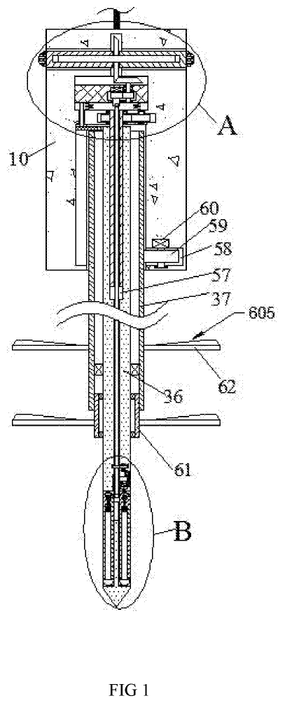

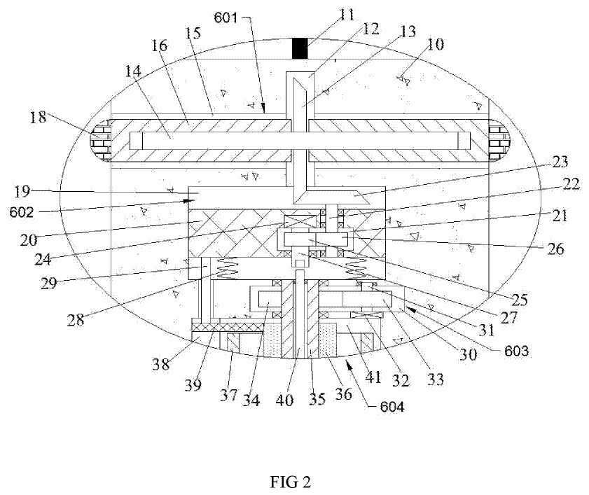

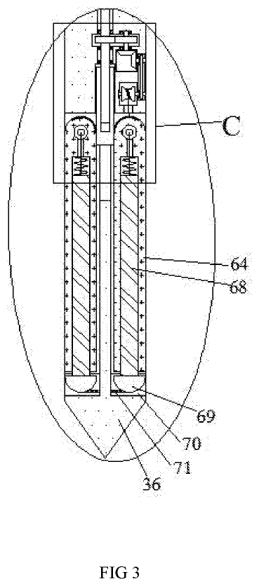

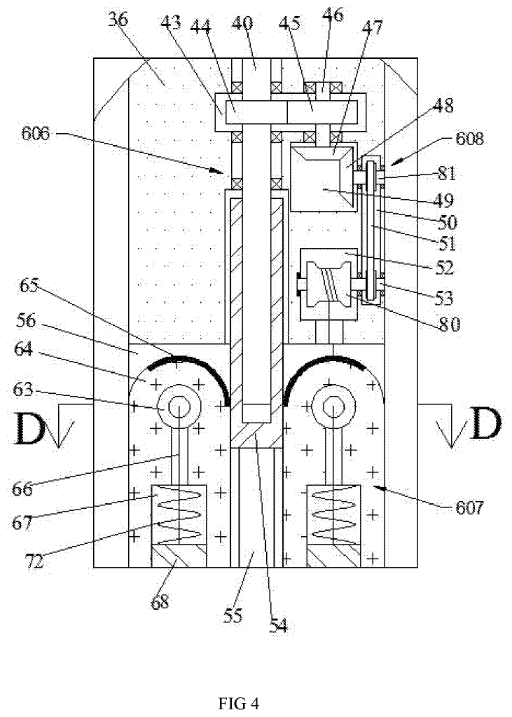

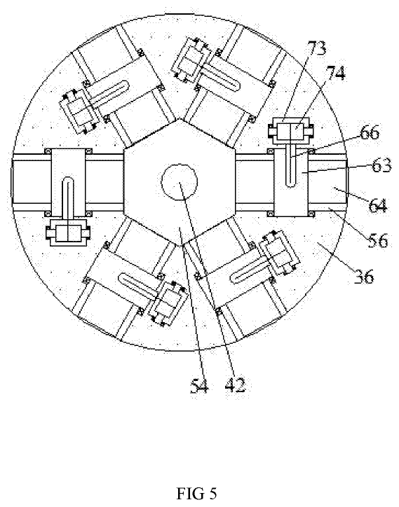

The present invention will now be described in detail with reference to FIGS. 1 to 5, and for the convenience of description, the orientations described below are now defined as follows: the up, down, left, and right front and rear directions described below are consistent with the up, down, left, and right front and rear directions of the projection relationship of FIG. 1 itself.

The invention relates to a dredging and dredging device for urban sewers, which is mainly used for dredging work of sewers. The present invention will be further described below in conjunction with the drawings of the present invention:

The utility model relates to a city sewer dredging device, which comprises a mounting block 10, a fixing rope 10 is fixed on an upper end surface of the mounting block 10, and a telescopic fixing device 601 is arranged in the mounting block 10, and the telescopic fixing device is arranged The 601 includes a left-right symmetric arc-shaped abutting block 18, and after the mounting block 10 is placed at a desired position in the sewer pipe, the abutting block 18 is closely adhered to the inner end wall of the sewer pipe, thereby The mounting block 10 is fixedly mounted in the sewer, and the power supply device 602 is disposed on the lower side of the telescopic fixing device 601. The power supply device 602 includes a power motor 24, and the power motor 24 can work for the telescopic The fixing device 601 is provided with a driving device 603. The lower side of the driving device 602 is provided with a lifting device 604. The lifting device 604 is electrically connected to the driving device 603. The device 604 includes a drill shaft 36. The drill shaft 36 is provided with a crushing device 605. The crushing device 605 can crush and separate the debris and sludge in the sewer from the sewer. With rotating device 606. The upper end of the rotating device 606 can be dynamically connected to the power supply device 602. The lower side of the rotating device 606 is provided with a filtering device 607. The filtering device 607 and the rotating device 606 are dynamically connected by a transmission device 608. The filter device 607 includes six extension blocks 69. The extension block 69 is provided with a retractable filter screen 71. When the mud and the debris are washed by the high-pressure water from the outside, the solid waste can pass through the filter net. 71 collection.

According to the embodiment, the telescopic fixing device 601 is described in detail below. The telescopic fixing device 601 includes a rotating slot 12, and the first bevel gear 13 is rotated in the rotating slot 12, and the lower end of the first bevel gear 13 is The power supply device 602 is connected to the power supply device. The first bevel gear 13 is fixed with a two-way screw 14 at the center thereof. The left and right sides of the rotating groove 12 are provided with a symmetric telescopic cavity 15, and the telescopic cavity 15 is slidably disposed. a telescopic shaft 16, wherein the left and right ends of the two-way screw 14 extend into the telescopic cavity 15, and the two-way screw 14 is screwed to the telescopic shaft 16, and the abutting block 18 is fixed to the telescopic shaft 16 is away from one end of the first bevel gear 13, so that the first bevel gear 13 drives the two-way screw 14 to rotate, so that the telescopic shaft 16 moves toward each other, and the abutting block 18 is controlled to closely fit the inner wall of the sewer pipe.

According to the embodiment, the power supply device 602 is described in detail below. The power supply device 602 includes a power chamber 19, and the power block 19 is slidably provided with a power block 20, and the lower end surface of the power block 20 is fixedly disposed. a symmetrical pressure spring 28 is disposed on the left side of the pressure spring 28, and the push block 29 is fixedly disposed on the lower end surface of the power block 20, and the lower end of the push block 29 abuts the lifting device 604. The power block 20 is provided with a power rotating slot 21, the power motor 24 is fixed on the upper end wall of the power rotating slot 21, and the power rotating slot 21 is rotated to be provided with a spline sleeve 27, the spline sleeve The upper end of the 27 is powered by the power motor 24, and the lower end of the spline sleeve 27 is connected to the rotating device 606. The spline sleeve 27 is fixed with a driving gear 25, and the right end of the driving gear 25 is meshed with A driven gear 26 is disposed at a center of the driven gear 26, and a gear rotating shaft 22 is fixed at a center thereof, and a second bevel gear 23 is fixed to an upper end of the gear rotating shaft 22, and the second bevel gear 23 and the first bevel gear 13 are engagement connection, so that the power motor 24 can work separately for the telescopic solid Said rotating means 601 and means 606 to provide power.

According to an embodiment, the driving device 603 is described in detail below. The driving device 603 includes a driving cavity 30. The lower end wall of the driving cavity 30 is fixed with a driving motor 32. The driving motor 32 is powered by a driving shaft 31. A first gear 33 is fixed on the drive shaft 31, and a second gear 34 is meshed and coupled to the left end of the first gear 33. The second gear 34 is fixedly connected to the lifting device 604, so that the driving motor 32 The work can drive the lifting device 604 to work.

According to the embodiment, the lifting device 604 is described in detail below. The lifting device 604 includes a lifting chamber 41. The lower side of the lifting chamber 41 communicates with the outside, and the upper end of the drilling shaft 36 is located in the lifting chamber 41. A threaded groove 57 is disposed in the drill shaft 36. The threaded groove 57 is internally threaded with a threaded shaft 35. The upper end of the threaded shaft 35 extends into the drive cavity 30 and is fixedly coupled to the second gear 34. A limiting block 39 is disposed on the left end surface of the drill shaft 36. A limiting slot 38 is defined in the left end wall of the lifting chamber 41. The left end of the limiting block 39 extends into the limiting slot 38. The limiting slot 38 The upper side is in communication with the power chamber 19, and the lower end of the push block 29 extends into the limiting slot 38 and abuts the limiting block 39, so that the threaded shaft 35 rotates to make the drill shaft 36 Lifting.

According to an embodiment, the comminating device 605 is described in detail below, the smashing device 605 includes an outer drum 37 having an outer surface having a vertical toothed structure, the outer drum 37 being sleeved on An outer circumference of the drill shaft 36 and an inner end surface of the outer drum 37 and the drill shaft 36 are rotatably connected by a bearing, and an inner end surface of the outer drum 37 is meshed with an inner drum 61. The inner drum 61 The drill shaft 36 is rotatably connected by a bearing, and the outer drum 37 and the inner drum 61 are respectively mounted with three pulverizing blades 62, and the pulverizing blades 62 are distributed in an annular array, and the mounting block 10 is arranged. a rotating cavity 58 is disposed therein, and the rotating cavity 58 is located in a right end wall of the lifting cavity 41. The rotating cavity 58 is rotated to be provided with a spur gear 59. The spur gear 59 is meshed with the outer rotating cylinder 37. The upper end wall of the rotating cavity 58 is mounted with a rotating motor 60, and the spur gear 59 is dynamically mounted with the rotating electric machine 60, so that the rotating electric machine 60 works to drive the spur gear 59 to rotate, then the outer rotating cylinder 37 and The inner drum 61 rotates, and the garbage in the sewer is broken by the smashing knife 62. Pass.

According to an embodiment, the rotating device 606 is described in detail below. The filtering device 607 includes a rotating shaft 40. The upper end of the rotating shaft 40 extends through the threaded shaft 35 and extends into the power chamber 19. The rotating shaft 40 The rotating shaft 40 is screwed to the six-sided cylinder 54. The six sides of the six-sided cylinder 54 are toothed, so that the rotating shaft 40 can rotate. The six-sided cylinder 54 is raised and lowered.

According to the embodiment, the filtering device 607 is described in detail below. The filtering device 607 includes six receiving cavities 56. The receiving cavity 56 is communicated with a through cavity 55. The lower end of the six-sided cylinder 54 extends to the In the through-cavity 55, a filter rotating shaft 63 is disposed in the receiving cavity 56, and a filtering rotating rod 64 is fixed on the filtering rotating shaft 63. The upper end surface of the filtering rotating rod 64 is provided with a curved rack 65. The curved rack 65 is meshed with the six-sided cylinder 54. The filter rod 64 is provided with a telescopic groove 67. The telescopic groove 67 is slidably provided with a telescopic rod 68, and the upper end of the telescopic rod 68 is disposed. A telescopic spring 72 is fixedly disposed between the telescopic groove 67, and the upper end of the telescopic rod 68 is fixed with a pull cord 66. The receiving cavity 56 is provided with a tensioning groove 73, and the tensioning groove The inner portion of the receiving cavity 56 is connected to the transmission device 608, and the lower end of the receiving cavity 56 is connected to the transmission device 608. The lower end of the telescopic rod 68 extends into the annular cavity 70 and the extension block 69 is fixed to the lower end of the telescopic rod 68, so that the six-sided cylinder 54 is under The filter rod 64 is rotated outward to rotate the filter screen 71, so that the expansion and contraction of the telescopic rod 68 in the telescopic groove 67 allows the filter screen 71 to match the inner diameter of the sewer.

According to the embodiment, the transmission device 608 is described in detail below. The transmission device 608 includes a winding chamber 52. The winding chamber 52 is located at an upper side of the receiving cavity 56, and the winding chamber 52 is disposed in the opposite direction. There is a winding shaft 53, a winding reel 80 is fixed on the winding shaft 53, and the upper ends of the six pulling ropes 66 are fixedly wound around the winding reel 80, and the winding chamber 52 is right. The belt end 50 is provided with a belt cavity 50, and the right end of the winding shaft 53 is rotatably connected with the right end wall of the belt chamber 50. The belt chamber 50 is rotated to provide a belt rotating shaft 81, and the belt rotating shaft 81 and the winding shaft The power transmission is carried out by a transmission belt 51. The left side of the belt cavity 50 is provided with a reversing chamber 49. The left end of the belt rotation shaft 81 extends into the reversing chamber 49 and a third bevel gear 48 is fixed. a fourth bevel gear 47 is coupled to the upper side of the third bevel gear 48. The transmission shaft 46 is fixed at the center of the fourth bevel gear 47, and the transmission groove 43 is disposed on the upper side of the reversing cavity 49. The upper end of the transmission shaft 46 extends into the transmission slot 43 and is fixed with a transmission gear 45. The rotating shaft 40 extends through the transmission slot 43. A meshing gear 44 is fixed on the rotating shaft 40 in the transmission groove 43, and the meshing gear 44 is meshed with the transmission gear 45, so that the meshing gear 44 rotates to drive the winding The runner 80 rotates to control the retraction of the drawstring 66.

The following describes the steps of using the urban sewer dredging device in conjunction with FIG. 1 to FIG. 5 in detail:

Initially, the telescopic shaft 16 is contracted into the telescopic cavity 15, and the lower end of the push block 29 abuts against the limiting block 39. At this time, the compression spring 28 is stretched, and the second bevel gear 23 meshes with the first bevel gear 13, and the spline sleeve 27 is not connected to the rotating shaft 40, the telescopic rod 68 is contracted in the telescopic groove 67, and the telescopic spring 72 is in a compressed state.

In use, the mounting block 10 is lowered to the desired position in the sewer by the rope 11, and the power motor 24 is operated to drive the driving gear 25 to rotate, and the second bevel gear 23 drives the first bevel gear 13 to rotate, thereby causing the two-way screw 14 to rotate, the telescopic shaft 16 moves backwards, and the abutting block 18 is closely attached to the inner wall of the sewage pipe, so that the mounting block 10 is fixedly installed in the sewer;

Thereafter, the driving motor 32 operates to drive the first gear 33 to rotate, so that the second gear 34 drives the threaded shaft 35 to rotate. Under the action of the limiting block 39, the drill shaft 36 is lowered, so that the filtering rotating rod 64 is located at the debris congested position. On the lower side, the smashing blade 62 is wrapped by the congested debris. At this time, the lowering of the limiting block 39 causes the pushing block 29 to descend, and the power block 20 is lowered, so that the second bevel gear 23 is separated from the first bevel gear 13. And the spline sleeve 27 is splined to the rotating shaft 40;

When the filter 71 is installed, when the power motor 24 is operated to rotate the rotating shaft 40, the six-sided cylinder 54 is lowered, so that the curved rack 65 drives the filter rotating rod 64 to rotate, so that the extending block 69 drives the filter 71 to rotate into the receiving cavity. 56 outside, when the filter rotating rod 64 is rotated to the horizontal position, the filter 71 is fully deployed, and during the rotation of the rotating shaft 40, the driving gear 45 is rotated, and the third bevel gear 48 is rotated, and the winding pulley is rotated by the transmission belt 51. When the rotation 80 is performed, the pull cord 66 is released, and the telescopic rod 68 is slid away from the side away from the curved rack 65 by the elastic restoring force of the telescopic spring 72, so that the extension block 69 is fitted to the inner wall of the sewage pipe. Then, the expanded area of the filter 71 is matched with the inner diameter of the sewer;

When the dredging is unblocked, the rotating motor 60 rotates to drive the spur gear 59 to rotate, so that the outer rotating cylinder 37 and the inner rotating cylinder 61 rotate, and the pulverizing knife 62 on the rotating knives can stir and crush the congested garbage or sludge. Therefore, the impurities are dispersed, and then, high-pressure water is injected into the sewer, and the crushed congested materials are washed away, and the fluid waste or the flowing sludge flows downward to the drainage system, and the solid waste is filtered and collected through the filter 71. Avoid being washed by high pressure water to the next sewer to cause blockage;

During the collection, when the driving motor 32 rotates in the reverse direction, the drill shaft 36 drives the garbage on the filter net 71 to rise, and when the drill shaft 36 rises to the initial position, the limiting block 39 pushes the push block 29 to rise, and the second bevel gear 23 and the second bevel gear 23 When the first bevel gear 13 is engaged and the spline sleeve 27 is disengaged from the rotating shaft 40, the power motor 24 operates to drive the second bevel gear 23 to rotate, and the bidirectional screw 14 rotates, so that the telescopic shafts 16 are close to each other, thereby mounting the mounting block 10 with The sewer is separated, the rope 11 is wound, and the mounting block 10 is pulled up to the ground, so that the solid waste in the filter 71 is taken out and collected.

The invention has the beneficial effects that the small volume of the invention can be directly placed in the sewer, fixedly installed by the telescopic fixing device and the sewer, and is suitable for use in sewers of different inner diameter ranges and depth ranges, and is crushed during the dredging process. The device smashes the clogged debris and the stuck sludge in the sewer, disperses between them, facilitates the subsequent high-pressure water scouring, clears the dredging speed, saves the water source, and the solid waste after the crushing is filtered through the filter. The collection can ensure the smooth flow of the sewer. The device has high automation, high efficiency, and safe operation.

In the above manner, those skilled in the art can make various changes depending on the mode of operation within the scope of the present invention.

1. A city sewer dredging apparatus, including a mounting block; the upper end surface of the mounting block is fixed with a rope, and the mounting block is provided with a telescopic fixing device. The telescopic fixing device includes a left-right symmetric arc-shaped abutting block, and the mounting block is placed in the sewage pipe. After the desired position, the abutting block is closely attached to the inner end wall of the sewer pipe, so that the mounting block is fixedly installed in the sewer; a power supply device is disposed on a lower side of the telescopic fixing device, the power supply device includes a power motor, the power motor works to provide power to the telescopic fixing device, and a driving device is disposed on a lower side of the power supply device. The lower side of the driving device is provided with a lifting device, the lifting device is dynamically connected with the driving device, the lifting device includes a drill shaft, and the drilling shaft is provided with a crushing device, and the crushing device can The debris and sludge in the sewer are broken up and separated from the sewer; a rotating device is disposed in the drill shaft, and the upper end of the rotating device is electrically connected to the power supply device, and the lower side of the rotating device is provided with a filtering device, and the filtering device and the rotating device are dynamically connected through the transmission device The filter device comprises six extension blocks, and a telescopic filter screen is installed between the extension blocks. When the mud and the debris are washed by the high-pressure water from the outside, the solid waste can be collected through the filter network.

2. The city sewer dredging apparatus according to claim 1, wherein the telescopic fixing device comprises a rotating groove; a first bevel gear is disposed in the rotating slot, a lower end of the first bevel gear is dynamically connected to the power supply device, and a bidirectional screw is fixed at a center of the first bevel gear; a symmetrical telescopic cavity is disposed in the left and right sides of the rotating slot, and a telescopic shaft is slidably disposed in the telescopic cavity, and the left and right ends of the two-way screw respectively extend into the telescopic cavity, and the two-way screw and the telescopic The shaft is screwed, and the abutting block is fixed to an end of the telescopic shaft away from the first bevel gear.

3. The city sewer dredging apparatus according to claim 1, wherein said power supply device comprises a power chamber; a power block is slidably disposed in the power chamber, and a pressure spring is symmetrically disposed on a lower end surface of the power block, and a push block is disposed on a left side of the pressure spring, and the push block is fixedly disposed under the power block An end surface, the lower end of the push block abuts the lifting device; a power rotating slot is disposed in the power block, the power motor is fixed on an upper end wall of the power rotating slot, and a spline sleeve is disposed in the power rotating slot, and the upper end of the spline sleeve is dynamically connected to the a power motor, the lower end of the spline sleeve is connected to the rotating device, the spline sleeve is fixed with a driving gear, and the right end of the driving gear is meshed with a driven gear, and the driven gear is fixed at the center of the driven gear There is a gear rotating shaft, and a second bevel gear is fixed to an upper end of the gear rotating shaft, and the second bevel gear is meshed with the first bevel gear.

4. The city sewer dredging apparatus according to claim 1, wherein said driving device comprises a driving chamber; a driving motor is fixed on the lower end wall of the driving cavity, a driving shaft is mounted on the driving motor, a first gear is fixed on the driving shaft, and a second gear is meshed and coupled to the left end of the first gear. The second gear is fixedly coupled to the lifting device.

5. The city sewer dredging apparatus according to claim 1, wherein said lifting device comprises a lifting chamber; the lower side of the lifting chamber communicates with the outside, the upper end of the drill shaft is located in the lifting chamber, the drill shaft is provided with a thread groove, the thread groove is internally threaded with a threaded shaft, and the upper end of the threaded shaft extends to The driving cavity is fixedly connected to the second gear, and the left end surface of the drill shaft is fixed with a limiting block; a limiting slot is disposed in the left end wall of the lifting chamber, a left end of the limiting block extends into the limiting slot, an upper side of the limiting slot communicates with the power cavity, and a lower end of the pushing block extends to the limiting slot is in contact with the limiting block.

6. The city sewer dredging apparatus according to claim 1, wherein the shredding device comprises an outer drum; the outer surface of the outer drum has a vertical tooth structure, the outer drum is sleeved on the outer circumference of the drill shaft, and the inner end surface of the outer drum and the drill shaft are rotatably connected by a bearing, the outer An inner drum is integrally connected to the inner end of the drum, and the inner drum is rotatably connected to the drill shaft through a bearing, and the outer drum and the inner drum are respectively mounted with three pulverizing knives, and the smashing The knives are distributed in a circular array; a rotating cavity is disposed in the mounting block, the rotating cavity is located in a right end wall of the lifting cavity, a rotating gear is arranged in the rotating cavity, and the spur gear is meshed with the outer rotating drum, and the rotating A rotating electric machine is mounted on the upper end wall of the chamber, and the spur gear is dynamically mounted with the rotating electric machine.

7. The city sewer dredging apparatus according to claim 1, wherein said filtering device comprises a rotating shaft; the upper end of the rotating shaft extends through the threaded shaft and extends into the power chamber, and the rotating shaft is rotatably connected to the threaded shaft through a bearing; the rotating shaft is screwed with a six-sided cylinder, and the six sides of the six-sided cylinder are all toothed.

8. The city sewer dredging apparatus according to claim 1, wherein the filtering device comprises six receiving chambers; a communication cavity is disposed between the receiving chambers, and a lower end of the six-sided cylinder extends into the through cavity, and a filter rotating shaft is disposed in the receiving cavity, and a filter rotating rod is fixed on the filtering rotating shaft. The upper end surface of the filter rotating rod is provided with a curved rack, and the curved rack meshes with the six sides of the six-sided cylinder; a telescopic groove is disposed in the filter rotating rod, and a telescopic rod is disposed in the telescopic groove, and a telescopic spring is fixed between the upper end of the telescopic rod and the telescopic groove, and the upper end of the telescopic rod is provided with a drawstring a tensioning groove is disposed on one side of the receiving cavity, and a tensioning rotating wheel is disposed in the tensioning rotating groove, and the upper end of the pulling rope is disposed around the tensioning wheel and the transmission device connection; an annular cavity is connected to the lower side of the receiving cavity, a lower end of the telescopic rod extends into the annular cavity, and the extension block is fixed at a lower end of the telescopic rod, so that the six-sided cylinder descends to drive the filtering The lever rotates to the outside.

9. The city sewer dredging apparatus according to claim 1, wherein the transmission device comprises a winding chamber; the winding chamber is located at an upper side of the receiving cavity, the winding chamber is provided with a winding shaft, and the winding shaft is fixed with a winding roller, and the upper ends of the three ropes are fixed. Winding on the winding reel; a right side of the winding chamber is provided with a belt cavity, and a right end of the winding shaft is rotatably connected to a right end wall of the belt cavity, and a belt rotating shaft is disposed in the belt cavity, and the belt rotating shaft and the winding shaft Powered by a drive belt; the left side of the belt cavity is provided with a reversing cavity, the left end of the belt rotating shaft extends into the reversing cavity and a third bevel gear is fixed, and the fourth bevel gear is meshed with the fourth bevel gear a drive shaft is fixed at a center of the fourth bevel gear; a transmission slot is disposed on the upper side of the reversing chamber, and an upper end of the transmission shaft extends into the transmission slot and a transmission gear is fixed, and the rotation shaft extends through the transmission slot, and the transmission slot An engaging gear is fixed on the rotating shaft, and the meshing gear is meshed with the transmission gear.
